(19) United States
(12) Patent Application Publication
(10) Pub. No.: US 2022/0410780 A1
(43) Pub. Date: Dec. 29, 2022

(54) SEAT WITH VIBRATION DEVICES

(71) Applicant: FAURECIA Sièges d'Automobile, NANTERRE (FR)

(72) Inventors: Sophia BENNIS, PARIS (FR); Jérôme PLANSON, ANGERVILLE (FR); Radouane BOUSSETTA, MASSY (FR); Anne-Isabelle MALLET-DA COSTA, ETRECHY (FR)

(21) Appl. No.: 17/361,559

(22) Filed: Jun. 29, 2021

(51) Int. Cl. B60N 2/90; A61H 1/00

(52) U.S. Cl. CPC B60N 2/976; A61H 1/005; A61H 2201/0149; A61H 2201/1623; A61H 2201/1635; A61H 2201/164; A61H 2205/062

(57) ABSTRACT

The present disclosure relates to a vehicle seat comprising a seating portion and a backrest, the seat further comprising at least one vibration device. The vibration device(s) are arranged in one or more of the following authorized spaces: a first authorized space in the backrest, which is defined by predefined ranges; a second authorized space in the seating portion, which is defined by predefined ranges; these ranges being defined with respect to an orthonormal coordinate system (H, x, y, z) whose origin is the point H which is the seating reference point of the seat, for which the x axis extends horizontally from the rear to the front of the seating portion, for which the y axis extends horizontally from the right to the left of the seat, and for which the z axis extends vertically from the bottom to the top of the backrest.

### BACKGROUND

The present disclosure relates to a vehicle seat comprising a seating portion with an upper face, and a backrest with a front face, the upper face and the front face being intended to be in contact with an occupant seated on the seat, this seat further comprising at least one vibration device.

### SUMMARY

According to the present disclosure, a vehicle seat comprises a seating portion with an upper face, and a backrest with a front face, the upper face and the front face being adapted to be in contact with an occupant seated on the seat. The seat further comprises at least one vibration device.

In illustrative embodiments, the vibration device(s) are arranged so that they generate minimal or no discomfort for the occupant. This is achieved by the fact that the vibration device(s) are arranged in one or more of the following authorized spaces:

a first authorized space (EA1) in the backrest, which is defined by the following ranges:

Y1min<|Y|<Y1max with Y1min=0 mm and Y1max=150 mm,

Z1min<Z<Z1max with Z1min=40 mm and Z1max=infinity,

|X|>|X_{D}|+L1 with L1=25 mm, where X_{D} is the x coordinate of point D of the front face 31 of the backrest 30 having coordinates Y and Z;

a second authorized space (EA2) in the seating portion, which is defined by the following ranges:

X>X2 min with X2 min=100 mm,

|Z|>|Z_{A}|+L2 with L2=25 mm, where Z_{A} is the z coordinate of point A of the upper face of the seating portion having coordinates X and Y;

the values X, Y and Z being the coordinates of a point P of the authorized space, these coordinates being defined with respect to an orthonormal coordinate system (H, x, y, z) whose origin is the point H which is the seating reference point of the seat, for which the x axis extends horizontally from the rear to the front of the seating portion, for which the y axis extends horizontally from the right to the left of the seat, and for which the z axis extends vertically from the bottom to the top of the backrest.

With these arrangements, the vibrations of the vibration device(s) do not adversely affect the health of the occupant. In particular, the vibration devices are in principle not placed near organs weakened by vibrations, in particular the lungs and genitals.

In illustrative embodiments, none of the vibration device(s) are placed in one of the following prohibited spaces:

a first prohibited space (EI1) in the backrest, which is defined by the following ranges:

|Y|<Y11max with Y11max=30 mm,

Z>0

a second prohibited space (EI2) in the seating portion and backrest, which is defined by the following ranges:

X12 min<X<X12max with X12 min=−100 mm and X12max=140 mm,

Z<Z12max with Z12max=40 mm,

a third prohibited space (EI3) in the seating portion and backrest, which is defined by the following ranges:

X<X13max with X13max=165 mm,

|Y|<Y13max with Y13max=40 mm,

Z<Z13max with Z13max=40 mm.

Thus, the most fragile areas of the body, which correspond to the torso where the lungs and heart are located and to the center of the body, are exposed as little as possible to vibrations, resulting in an absence of discomfort or adverse effect on the health of the occupant seated in the seat.

In illustrative embodiments, Y1min=30 mm, Z1max=200 mm, and X2 min=165 mm.

The authorized areas are thus less extensive, which reduces unwanted vibrations in areas of the body to be protected from vibrations.

In illustrative embodiments, the authorized spaces of the seat further comprise a third authorized space which consists of the armrests, the lateral parts of the backrest which are intended to support the shoulders of an occupant of the seat, and the footrests of the seat.

The vibrations of the vibration device can thus be felt by other areas of the body, which may be beneficial to the occupant.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a seat according to the present disclosure;

FIG. 2 is a front view of the seat of FIG. 1;

FIG. 3 is a top view of the seat of FIG. 1; and

FIG. 4 is a section view along plane IV-IV of FIG. 3.

### DETAILED DESCRIPTION

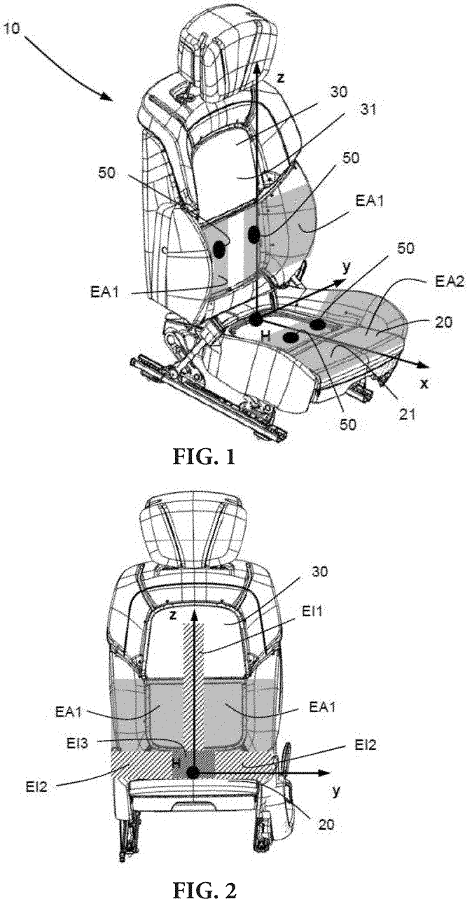

A vehicle seat 10 comprises a seating portion 20 and a backrest 30, as shown in FIG. 1, which is a perspective view of a seat 10. The “front-to-back” direction is defined in the direction of the seating portion 20 relative to an occupant normally seated on the seat, this occupant then looking forward, the occupant's back then being directed rearward. The left and right of the seat are also defined relative to such an occupant, the left (respectively right) of the seat 10 being on the left (respectively right) side of the occupant. The “top-borrom” direction is defined in the direction of the backrest 30, such that the bottom is where the backrest 30 and the seating portion 20 meet, and the top is the top of the backrest 30.

The seating portion 20 has an upper face 21, and the backrest 30 has a front face 31, the upper face 21 and the front face 31 being intended to be respectively in contact with the buttocks/legs and the back of an occupant seated in the seat 10.

We define an orthonormal coordinate system (Hxyz) with respect to the seat 10 as follows: the origin H is the “seating reference point” of the seat 10, called “point H”, the x axis extends horizontally from the rear towards the front of the seating portion 20, the y axis extends horizontally (transversely) from the right to the left of the seat, and the z axis extends vertically from the bottom to the top of the backrest 30.

The “seating reference point” is a standard defined throughout the automotive industry as being the pivot point between the torso and the legs (thighs) of a SAE-J826 manikin sitting on the seat.

In the present description, the X, Y, and Z values are the coordinates of a point M which are defined in the reference system (Hxyz) and are expressed in millimeters (mm). These values may be negative or positive, depending on the position of the point M.

The seat 10 has one or more vibration devices 50 which are integrated into the seating portion 20 and/or the backrest 30 of the seat 10.

Tests carried out with occupants of various builds and sizes seated on a seat 10 show that when the vibration devices 50 are arranged in certain areas of the seat 10, called “authorized spaces” (EA), an occupant does not perceive any discomfort or hindrance due to the vibrations generated by the vibration devices 50. The vibration devices 50 should therefore be ideally placed in these authorized spaces EA.

These tests also show that, conversely, when the vibration devices 50 are arranged in certain areas of the seat 10, called “prohibited spaces” (EI), an occupant perceives discomfort. In addition, the vibrations of the vibration devices 50 may be harmful to the health of the occupant because they cause vital organs (heart, lungs, genitals, etc.) of the occupant to resonate. The vibration devices 50 therefore should not be placed in these prohibited spaces EI.

In the description below, the notation |T| means, in the standard manner, the absolute value of T, in other words |T|=T if T>0 and |T|=−T if T<0. We will now describe and quantify the authorized spaces EA.

A first authorized space EA1, which is in the backrest 30, is defined by the following ranges:

Y1min<|Y|<Y1max with Y1min=0 mm and Y1max=150 mm,

Z1min<Z<Z1max with Z1min=40 mm and Z1max=infinity,

|X|>|X_{D}|+L1 with L1=25 mm, where X_{D} is the x coordinate of point D of the front face 31 of the backrest 30 having coordinates Y and Z.

In a restrictive variant, the authorized space EA1 is restricted with the values Y1min=30 mm and Z1max=200 mm. In this variant, the central area of the backrest 31, namely a strip around the z axis whose width is equal to {2Y1min}=60 mm, is removed from the authorized space EA1. This central area corresponds to the part of the backrest 31 where the occupant's spine rests. Secondly, the upper portion of the backrest 31, namely above Z1max=200 mm, is removed from the authorized space EA1. This upper portion corresponds to the part of the backrest where the occupant's lungs rest. FIG. 2 is a front view of the seat 10 and shows the authorized space EA1 in the case of this restrictive variant. This authorized space EA1 is also visible in FIG. 1 and in FIG. 4. As an example, four vibration devices 50 are arranged in the seat 10 (two in the backrest 30 and two in the seating portion 20) and represented in these figures. The vibration devices 50 are arranged symmetrically with respect to plane (x, z).

FIG. 4 shows the relative position of a point P of the authorized space having coordinates X, Y, Z, and of a point D having coordinates X_{D}, Y, Z. Point D is the projection, on the front face 31 and along the x direction, of point P. Thus, the condition |X|>|X_{D}|+L1 means that point P is located behind the backrest 30 at a distance from the front face 31 at least equal to L1. The points P which satisfy this condition are located in the gray area of the backrest 31 in FIG. 4.

A second authorized space EA2, which is in the seating portion 20, is defined by the following ranges:

X>X2 min with X2 min=100 mm,

|Z|>|Z_{A}|+L2 with L2=25 mm, where Z_{A} is the z coordinate of point A of the upper face 21 of the seating portion 20 having coordinates X and Y.

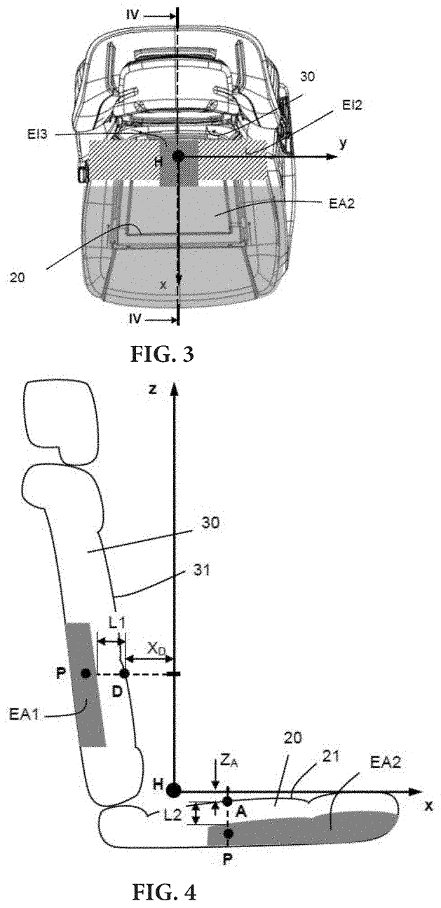

In a restrictive variant, the authorized space EA2 is restricted with the value X2 min=165 mm. In this variant, a portion located further to the rear of the seating portion 21, namely between X2 min=100 mm and X2 min=165 mm, is removed from the authorized space EA2. This portion corresponds to the part of the seating portion 20 which is closest to the occupant's genitals. FIG. 3 is a top view of the seat 10 and shows the authorized space EA2 in the case of this restrictive variant. This authorized space EA2 is also visible in FIG. 1 and in FIG. 4.

FIG. 4 shows the relative position of a point P of the authorized space having coordinates X, Y, Z, and of a point A having coordinates X, Y, Z_{A}. Point A is the projection, on the upper face 21 and along the z direction, of point P. Thus, the condition |Z|>|Z_{A}|+L2 means that point P is located under the seating portion 20 at a distance from the upper face 21 at least equal to L2. The points P which satisfy this condition are located in the gray area of the seating portion 21 in FIG. 4.

We now describe and quantify the prohibited spaces EI.

A first prohibited space EI1, which is in the backrest 30, is defined by the following ranges:

|Y|<Y11max with Y11max=30 mm,

Z>0.

This prohibited space EI1 corresponds to a central area of the backrest 30 which is a strip around the z axis of a width equal to {2·Y11max}=60 mm. This central area corresponds to the part of the backrest 30 where the occupant's spine rests. Indeed, it is preferable that the vibration devices 50 not be located in this area. This prohibited space EI1 is visible in FIG. 2.

A second prohibited space EI2, which is in the seating portion 20 and the backrest 30, is defined by the following ranges:

X12 min<X<X12max with X12 min=−100 mm and X12max=140 mm,

Z<Z12max with Z12max=40 mm.

This prohibited space EI2 corresponds to an area of the seat 10 which on the one hand extends over the entire width of the seat 10, to behind point H for a distance of X12 min and to in front of point H for a distance of X12max, and on the other hand extends to below a height Z12max. This area corresponds to the part of the seat 10 where the central portion of the occupant's body rests. Indeed, it is preferable that the vibration devices 50 not be located in this area which comprises the central organs and bones of the body. This prohibited space EI2 is visible in FIG. 2 and FIG. 3.

A third prohibited space EI3, which is in the seating portion 20 and the backrest 30, is defined by the following ranges:

X<X13max with X13max=165 mm,

|Y|<Y13max with Y13max=40 mm,

Z<Z13max with Z13max=40 mm.

This prohibited space EI3 corresponds to an area of the seat 10 which extends on the one hand as a strip around the x axis behind X13max and over a width equal to {2·Y13max}=80 mm, and on the other hand which extends to below a height Z13max. This area corresponds to the part of seat 10 where the occupant's genitals rest. Indeed, it is preferable that the vibration devices 50 are not located in this area. This prohibited space EI3 is visible in FIG. 2 and FIG. 3.

According to one variant of the present disclosure, the authorized spaces of the seat 10 further comprise a third authorized space which consists of the armrests, the lateral parts of the backrest 30 intended to support the shoulders of an occupant of the seat 10, and the footrests of the seat 10 if these footrests are present.

According to one variant of the present disclosure, the authorized spaces of the seat 10 further comprise a third authorized space which comprises of the armrests, the lateral parts of the backrest 30 intended to support the shoulders of an occupant of the seat 10, and the footrests of the seat 10 if these footrests are present.

According to one variant of the present disclosure, the vibration devices 50 are arranged exclusively in one or more of the authorized spaces EA defined above.

This present disclosure relates to a vehicle seat comprising a seating portion with an upper face, and a backrest with a front face, the upper face and the front face being intended to be in contact with an occupant seated on the seat, this seat further comprising at least one vibration device.

There may be comparative vehicle seats having integrated vibration devices which are integrated into a seat in order to transmit vibrations to the occupant seated on the seat. These vibrations may be generated by the vibrator of the vibration device. The transmission of these vibrations to the occupant may have a variety of purposes, such as the occupant's comfort or warning the occupant of a hazard outside the vehicle.

Depending on the position of the vibration devices in the comparative seat, the vibrations generated by them may cause discomfort for the occupant, or may even be harmful to the health at certain vibration frequencies.

The present disclosure aims to remedy these disadvantages of the comparative seat.

The present disclosure aims to provide a vehicle seat in which the vibration device(s) are arranged so that they generate minimal or no discomfort for the occupant.

This goal is achieved by the fact that the vibration device(s) are arranged in one or more of the following authorized spaces:

a first authorized space (EA1) in the backrest, which is defined by the following ranges:

Y1min<|Y|<Y1max with Y1min=0 mm and Y1max=150 mm,

Z1min<Z<Z1max with Z1min=40 mm and Z1max=infinity,

|X|>|X_{D}|+L1 with L1=25 mm, where X_{D} is the x coordinate of point D of the front face 31 of the backrest 30 having coordinates Y and Z;

a second authorized space (EA2) in the seating portion, which is defined by the following ranges:

X>X2 min with X2 min=100 mm,

|Z|>|Z_{A}|+L2 with L2=25 mm, where Z_{A} is the z coordinate of point A of the upper face of the seating portion having coordinates X and Y;

the values X, Y and Z being the coordinates of a point P of the authorized space, these coordinates being defined with respect to an orthonormal coordinate system (H, x, y, z) whose origin is the point H which is the seating reference point of the seat, for which the x axis extends horizontally from the rear to the front of the seating portion, for which the y axis extends horizontally from the right to the left of the seat, and for which the z axis extends vertically from the bottom to the top of the backrest.

With these arrangements, the vibrations of the vibration device(s) do not adversely affect the health of the occupant. In particular, the vibration devices are in principle not placed near organs weakened by vibrations, in particular the lungs and genitals.

In one example, none of the vibration device(s) are placed in one of the following prohibited spaces:

a first prohibited space (EI1) in the backrest, which is defined by the following ranges:

|Y|<Y11max with Y11max=30 mm,

Z>0

a second prohibited space (EI2) in the seating portion and backrest, which is defined by the following ranges:

X12 min<X<X12max with X12 min=−100 mm and X12max=140 mm,

Z<Z12max with Z12max=40 mm,

a third prohibited space (EI3) in the seating portion and backrest, which is defined by the following ranges:

X<X13max with X13max=165 mm,

|Y|<Y13max with Y13max=40 mm,

Z<Z13max with Z13max=40 mm.

Thus, the most fragile areas of the body, which correspond to the torso where the lungs and heart are located and to the center of the body, are exposed as little as possible to vibrations, resulting in an absence of discomfort or adverse effect on the health of the occupant seated in the seat.

In one example, Y1min=30 mm, Z1max=200 mm, and X2 min=165 mm.

The authorized areas are thus less extensive, which reduces unwanted vibrations in areas of the body to be protected from vibrations.

In one example, the authorized spaces of the seat further comprise a third authorized space which consists of the armrests, the lateral parts of the backrest which are intended to support the shoulders of an occupant of the seat, and the footrests of the seat.

The vibrations of the vibration device can thus be felt by other areas of the body, which may be beneficial to the occupant.

The following numbered clauses include embodiments that are contemplated and non-limiting:

Clause 1. A Vehicle seat (10) comprising a seating portion (20) with an upper face (21), and a backrest (30) with a front face (31), the upper face (21) and the front face (31) being intended to be in contact with an occupant seated on the seat (10), the seat (10) further comprising at least one vibration device (50), the seat (10) being characterized in that the at least one vibration device (50) is arranged in one or more of the following authorized spaces:

a first authorized space (EA1) in the backrest (30), which is defined by the following ranges:

Y1min<|Y|<Y1max with Y1min=0 mm and Y1max=150 mm,

Z1min<Z<Z1max with Z1min=40 mm and Z1max=infinity,

|X|>|X_{D}|+L1 with L1=25 mm, where X_{D} is the x coordinate of point D of the front face (31) of the backrest (30) having coordinates Y and Z;

a second authorized space (EA2) in the seating portion (20), which is defined by the following ranges:

X>X2 min with X2 min=100 mm,

|Z|>|Z_{A}|+L2 with L2=25 mm, where Z_{A} is the z coordinate of point A of the upper face (21) of the seating portion (20) having coordinates X and Y;

the values X, Y, and Z being the coordinates of a point P of the authorized space, these coordinates being defined with respect to an orthonormal coordinate system (H, x, y, z) whose origin is the point H which is the seating reference point of the seat (10), for which the x axis extends horizontally from the rear to the front of the seating portion (20), for which the y axis extends horizontally from the right to the left of the seat, and for which the z axis extends vertically from the bottom to the top of the backrest (30).

Clause 2. Vehicle seat (10) according to clause 1, wherein none of the at least one vibration device (50) is placed in one of the following prohibited spaces:
a first prohibited space (EI1) in the backrest (30), which is defined by the following ranges:

|Y|<Y11max with Y11max=30 mm,

Z>0
a second prohibited space (EI2) in the seating portion (20) and the backrest (30), which is defined by the following ranges:

X12 min<X<X12max with X12 min=−100 mm and X12max=140 mm,

Z<Z12max with Z12max=40 mm,
a third prohibited space (EI3) in the seating portion (20) and the backrest (30), which is defined by the following ranges:

X<X13max with X13max=165 mm,

|Y|<Y13max with Y13max=40 mm,

Z<Z13max with Z13max=40 mm.

Clause 3. Vehicle seat (10) according to clauses 1 or 2, wherein

Y1min=30 mm, Z1max=200 mm, and X2 min=165 mm.

Clause 4. Vehicle seat (10) according to any one of clauses 1 to 3, wherein the authorized spaces of the seat (10) further comprise a third authorized space which consists of the armrests, the lateral parts of the backrest (30) which are intended to support the shoulders of an occupant of the seat (10), and the footrests of the seat (10).

1. A vehicle seat comprising
a seating portion with an upper face, and a backrest with a front face, the upper face and the front face being intended to be in contact with an occupant seated on the seat,
at least one vibration device,
wherein the at least one vibration device is arranged in one or more of the following authorized spaces:
a first authorized space in the backrest, which is defined by the following ranges:
Y1min<|Y|<Y1max with Y1min=0 mm and Y1max=150 mm,
Z1min<Z<Z1max with Z1min=40 mm and Z1max=infinity,

|X|>|X_{D}|+L1 with L1=25 mm, where X_{D} is the x coordinate of point D of the front face of the backrest having coordinates Y and Z;
a second authorized space in the seating portion, which is defined by the following ranges:
X>X2 min with X2 min=100 mm,

|Z|>|Z_{A}|+L2 with L2=25 mm, where Z_{A} is the z coordinate of point A of the upper face of the seating portion having coordinates X and Y;
the values X, Y, and Z being the coordinates of a point P of the authorized space, these coordinates being defined with respect to an orthonormal coordinate system (H, x, y, z) whose origin is the point H which is the seating reference point of the seat, for which the x axis extends horizontally from the rear to the front of the seating portion, for which the y axis extends horizontally from the right to the left of the seat, and for which the z axis extends vertically from the bottom to the top of the backrest.

2. The vehicle seat of claim 1, wherein none of the at least one vibration device is placed in one of the following prohibited spaces:
a first prohibited space in the backrest, which is defined by the following ranges:

|Y|<Y11max with Y11max=30 mm,
Z>0
a second prohibited space (EI2) in the seating portion (20) and the backrest (30), which is defined by the following ranges:
X12 min<X<X12max with X12 min=−100 mm and X12max=140 mm,
Z<Z12max with Z12max=40 mm,
a third prohibited space (EI3) in the seating portion (20) and the backrest (30), which is defined by the following ranges:
X<X13max with X13max=165 mm,

|Y|<Y13max with Y13max=40 mm,
Z<Z13max with Z13max=40 mm.

3. The vehicle seat of claim 1, wherein Y1min=30 mm, Z1max=200 mm, and X2 min=165 mm.

4. The vehicle seat of claim 1, wherein the authorized spaces of the seat further comprise a third authorized space which consists of the armrests, the lateral parts of the backrest which are intended to support the shoulders of an occupant of the seat, and the footrests of the seat.
